(19) United States
(12) Patent Application Publication
(10) Pub. No.: US 2021/0135591 A1
(43) Pub. Date: May 6, 2021

(54) POWER CONVERSION DEVICE

(71) Applicant: Panasonic Intellectual Property Management Co., Ltd., Osaka (JP)

(72) Inventor: Kazuya IKEDA, Kanagawa (JP)

(21) Appl. No.: 17/146,243

(22) Filed: Jan. 11, 2021

Related U.S. Application Data
(63) Continuation of application No. PCT/JP2019/027944, filed on Jul. 16, 2019.

(30) Foreign Application Priority Data
Aug. 10, 2018 (JP) 2018-151085

(51) Int. Cl. H02M 7/162; H02M 1/08; H02J 7/00

(52) U.S. Cl. CPC H02M 7/1623; H02M 1/08; H02M 1/4208; H02J 2207/20; H02J 7/007

(57) ABSTRACT

This power conversion device converts AC power to DC power and is provided with: a rectifier unit including a thyristor; a capacitor provided at a stage subsequent to the rectifier unit; and a control unit for controlling the firing of the thyristor. The control unit fires the thyristor after a predetermined time from when a zero-cross point where the voltage of the AC power is zero has been reached, thereby supplying power to the capacitor, said predetermined time being determined in accordance with a predetermined frequency of the AC power. The control unit also sets the predetermined time short every time when firing the thyristor and, when the frequency of the AC power has deviated from the predetermined frequency, performs control so as not to fire the thyristor after the predetermined time determined in accordance with the predetermined frequency.

### TECHNICAL FIELD

The present disclosure relates to a power conversion apparatus.

### BACKGROUND ART

In a power conversion apparatus configured to convert AC power into DC power, such as one used in a charger or the like, a capacitor for voltage smoothing is precharged by utilizing a thyristor. For example, Patent Literature (hereinafter, referred to as “PTL”) 1 uses a thyristor as a rectifier device, and discloses a configuration in which a thyristor is fired in accordance with a difference value between a voltage of AC power and a voltage charged to a capacitor.

Incidentally, when a malfunction occurs in which a voltage value of AC power at the time of starting firing of a thyristor deviates from an assumed voltage value (hereinafter, the malfunction will be referred to as “erroneous firing”), an excessive inrush current may be generated to affect a circuit and/or the like of a power conversion apparatus in a case where the difference value described above is large. Accordingly, for example, PTL 2 discloses a configuration for preventing the erroneous firing described above by detecting a pulse-shaped voltage drop or an instantaneous voltage decline in an input voltage.

### CITATION LIST

### Patent Literature

### PTL 1

### Japanese Patent No. 4337032

### PTL 2

Japanese Patent Application Laid-Open No. H08-275532

### SUMMARY OF INVENTION

### Technical Problem

However, in a case where a frequency of AC power has fluctuated, the erroneous firing described above may easily occur since voltage values of the AC power before and after the fluctuation at a timing of firing a thyristor diverge from each other. The configuration described in PTL 2 does not take a fluctuation in a frequency of AC power into consideration so that there is a certain limit as a configuration for preventing erroneous firing of a thyristor.

An object of the present disclosure is to provide a power conversion apparatus capable of preventing erroneous firing of a thyristor.

### Solution to Problem

A power conversion apparatus according to the present disclosure is a power conversion apparatus that converts AC power into DC power, the power conversion apparatus including:

a rectifier including a thyristor;

a capacitor provided at a stage subsequent to the rectifier; and

a controller that controls firing of the thyristor, wherein

the controller causes power to be supplied to the capacitor by performing the firing of the thyristor after a predetermined time from when a voltage of the AC power has reached a zero-cross point, and sets the predetermined time short every time the firing of the thyristor is performed, the predetermined time being determined in accordance with a predetermined frequency of the AC power, the zero-cross point being where the voltage of the AC power is zero, and

in a case where a frequency of the AC power has fluctuated from the predetermined frequency, the controller performs control such that the firing of the thyristor is not performed after the predetermined time determined in accordance with the predetermined frequency.

### Advantageous Effects of Invention

According to the present disclosure, it is possible to prevent erroneous firing of a thyristor.

### BRIEF DESCRIPTION OF DRAWINGS

FIG. 1 illustrates a power conversion apparatus according to an embodiment of the present disclosure;

FIG. 2 is a time chart for describing thyristor firing control;

FIG. 3 is a time chart for describing an example in which a thyristor firing timing deviates;

FIG. 4A is a diagram for describing voltage ranges set for each predetermined timing;

FIG. 4B is a diagram for describing an example of determination of a frequency fluctuation of AC power;

FIG. 5 is a flowchart illustrating an example of operation of the thyristor firing control in the power conversion apparatus;

FIG. 6 illustrates a voltage waveform of the AC power when a sudden voltage fluctuation occurs; and

FIG. 7 illustrates a power conversion apparatus according to a variation of the embodiment.

### DESCRIPTION OF EMBODIMENTS

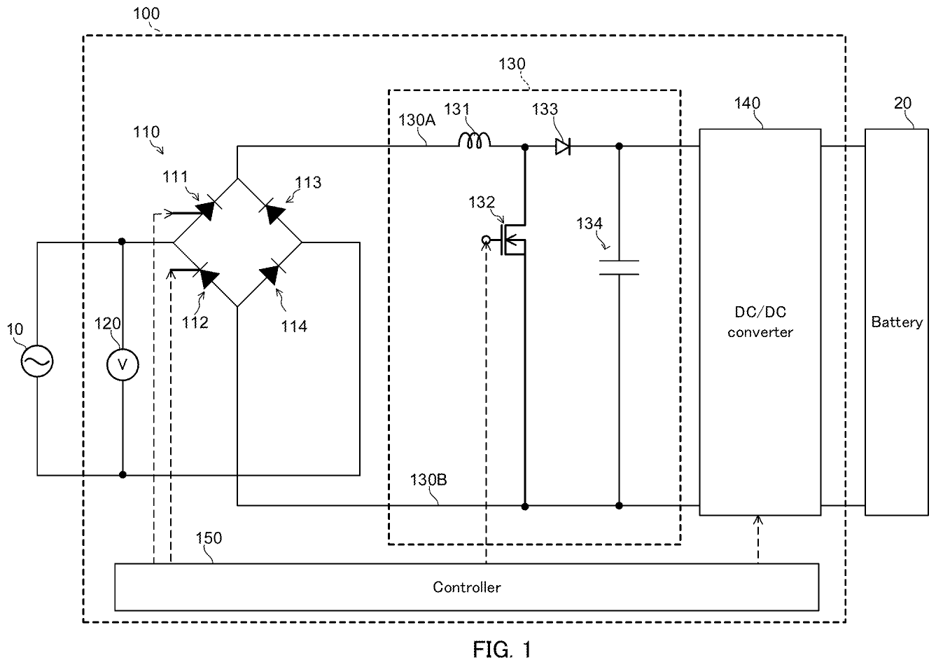

Hereinafter, an embodiment of the present disclosure will be described in detail based on the accompanying drawings. FIG. 1 illustrates power conversion apparatus 100 according to the embodiment of the present disclosure.

As illustrated in FIG. 1, power conversion apparatus 100 is a charger which is connected to external AC power supply 10, and which charges battery 20 by converting AC power supplied from external AC power supply 10 into DC power. Battery 20 is, for example, a battery mounted on a vehicle such as an electric car and a hybrid vehicle.

Power conversion apparatus 100 includes rectifier 110, voltage detector 120, power factor corrector 130, DC/DC converter 140, and controller 150.

Rectifier 110 includes a bridge circuit formed of first thyristor 111, second thyristor 112, first diode 113, and second diode 114.

First thyristor 111 includes an anode connected to a positive electrode of external AC power supply 10, and a cathode connected to input wiring 130A of power factor corrector 130. Further, first thyristor 111 includes a gate connected to controller 150.

Second thyristor 112 includes an anode connected to ground wiring 130B of power factor corrector 130, and a cathode connected to the positive electrode of external AC power supply 10. Second thyristor 112 includes a gate connected to controller 150.

First diode 113 includes an anode connected to a negative electrode of external AC power supply 10, and a cathode connected to input wiring 130A of power factor corrector 130.

Second diode 114 includes an anode connected to ground wiring 130B of power factor corrector 130, and a cathode connected to the negative electrode of external AC power supply 10.

Controller 150 controls firing of first thyristor 111 and second thyristor 112. Specifically, controller 150 adjusts conduction states of first thyristor 111 and second thyristor 112 by applying a voltage to each gate of first thyristor 111 and second thyristor 112. First thyristor 111 and second thyristor 112 are fired, and thereby rectifier 110 converts AC power output from external AC power supply 10 into DC power by full-wave rectification, and outputs the DC power to power factor corrector 130. Control of rectifier 110 will be described later.

Voltage detector 120 is a voltage sensor configured to detect a voltage value of AC power input to rectifier 110, and is provided at a stage preceding rectifier 110.

Power factor corrector 130 is a power factor correction circuit configured to correct the power factor of DC power input from rectifier 110. Power factor corrector 130 includes coil 131, switching device 132, diode 133, and capacitor 134.

Coil 131 is provided in input wiring 130A. Coil 131 includes one end connected to an output terminal on a side of the cathode of first thyristor 111 of rectifier 110, and the other end connected to the anode of diode 133.

Switching device 132 is a field effect transistor, and is provided between input wiring 130A and ground wiring 130B. Specifically, switching device 132 includes a drain connected to the other end of coil 131 in input wiring 130A and to the anode of diode 133, and a source connected to ground wiring 130B of power factor corrector 130. Switching device 132 includes a gate connected to controller 150.

Diode 133 is provided in input wiring 130A. Diode 133 includes an anode connected to the other end of coil 131, and a cathode connected to DC/DC converter 140.

Capacitor 134 is provided at a stage subsequent to diode 133. Specifically, capacitor 134 includes one end connected to the cathode of diode 133, and the other end connected to a ground of power factor corrector 130. Thus, an electric charge corresponding to the output of power factor corrector 130 is charged to capacitor 134, and DC power output from power factor corrector 130 is smoothed.

DC/DC converter 140 is a circuit configured to convert DC power output from power factor corrector 130 into DC power that can be charged to battery 20, and is connected at a stage subsequent to power factor corrector 130. Controller 150 controls a switching device (not illustrated) mounted on DC/DC converter 140. Thus, DC power converted by DC/DC converter 140 is output to battery 20 to charge battery 20.

Controller 150 includes a central processing unit (CPU) (not illustrated), a read only memory (ROM) (not illustrated), a random access memory (RAM) (not illustrated), and an input/output circuit (not illustrated). Controller 150 is configured to control, in addition to power factor corrector 130 and DC/DC converter 140, firing of first thyristor 111 and second thyristor 112, based on a preset program. Note that, in the following description, first thyristor 111 and second thyristor 112 are simply referred to as “thyristor” in a case where they are not particularly distinguished.

Controller 150 controls an amount of DC power output from rectifier 110 by controlling firing of the thyristor. Specifically, in a case where a voltage is precharged to capacitor 134, controller 150 adjusts a firing timing of the thyristor in accordance with a voltage value of capacitor 134 such that the voltage value increases stepwise.

The reason for this will be described below.

To cause power factor corrector 130 of power conversion apparatus 100 to operate normally, it is necessary to perform precharging such that a voltage value of capacitor 134 becomes a desired voltage value. However, in a case where capacitor 134 is not sufficiently charged, a difference between a voltage value of capacitor 134 and a voltage value of AC power becomes excessive. As a result, an excessive inrush current may occur due to the difference to affect a peripheral circuit.

Accordingly, controller 150 adjusts a firing timing of the thyristor such that the voltage value of capacitor 134 increases stepwise.

In more detail, controller 150 performs firing of one of first thyristor 111 and second thyristor 112 for a fixed term after a predetermined time from when a voltage value of AC power output from external AC power supply 10 has reached a zero-cross point where the voltage value of the AC power is zero. First thyristor 111 is fired when the voltage value of the AC power is a positive value. Second thyristor 112 is fired when the voltage value of the AC power is a negative value.

The predetermined time is a time determined in accordance with a predetermined frequency and is, for example, a time equivalent to a time less than a half period of the predetermined frequency. The predetermined frequency is a frequency of AC power and is, for example, a frequency identified by controller 150 based on a voltage value of the AC power detected by voltage detector 120.

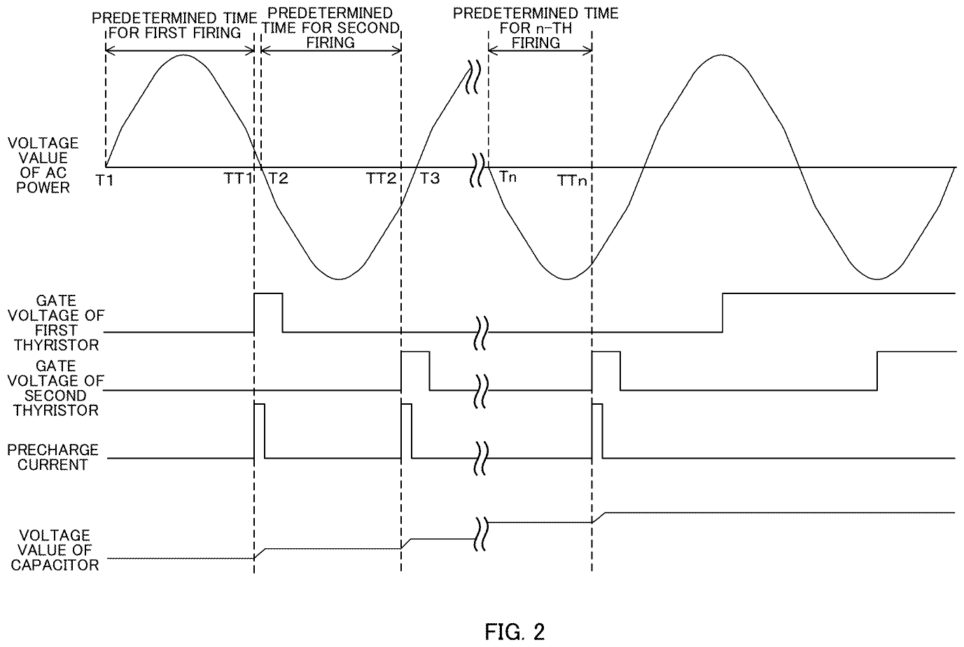

Then, controller 150 sets the predetermined time short every time the firing of one of first thyristor 111 and second thyristor 112 is performed. Thyristor firing control will be described in detail with reference to FIG. 2.

As illustrated in FIG. 2, the firing of the thyristor is started at time TT1 after the output of AC power has been started and a predetermined time (a predetermined time for first firing) has elapsed from time T1 serving as the zero-cross point. Since the voltage value of the AC power from time T1 to time T2 is a positive value, first thyristor 111 is fired at time TT1. At this time, the voltage value of capacitor 134 is set to zero. Note that, time T2 is a time when a time equivalent to a half period of the AC power has elapsed from time T1.

The predetermined time for the first firing is a time equivalent to from a phase angle of the AC power of 0° (equivalent to a point corresponding to time T1) to a phase angle of the AC power (time TT1) slightly smaller than a phase angle of the AC power of 180° (a point corresponding to time T2). The predetermined time for the first firing is a time such that an inrush current generated due to a voltage value equivalent to a voltage value of the AC power when the predetermined time has elapsed becomes such a value that does not affect a peripheral circuit, and is appropriately set by an experiment or the like.

When the first firing is started, a current based on a difference between a voltage value of the AC power at the time of starting the first firing and a voltage value of capacitor 134 (hereinafter, the current will be referred to as “precharge current”) flows, and thereby an electric charge equivalent to the precharge current is charged to capacitor 134. Thus, the voltage value of capacitor 134 increases to a voltage value corresponding to the electric charge. Since the voltage of the AC power decreases between time TT1 and time T2 and the voltage value of capacitor 134 does not increase any further, first thyristor 111 automatically stops and the precharge current also stops.

Note that, a voltage is applied to the gate of first thyristor 111 for a fixed term (a term from time TT1 to a time slightly past time T2) by controller 150 (see “gate voltage of first thyristor” in FIG. 2).

After the AC power has reached the zero-cross point at time T2, the firing of the thyristor is started at time TT2 after a predetermined time (a predetermined time for second firing) has elapsed from time T2. Since the voltage value of the AC power from time T2 to time T3 is a negative value, second thyristor 112 is fired at time TT2. Note that, time T3 is a time when the time equivalent to the half period of the AC power has elapsed from time T2.

The predetermined time for the second firing is a time shorter than the predetermined time for the first firing. The predetermined time for the second firing is a time such that an inrush current generated due to a voltage value equivalent to a difference value between a voltage value of the AC power when the predetermined time has elapsed and a voltage value of capacitor 134 becomes such a value that does not affect a peripheral circuit, and is appropriately set by an experiment or the like.

When the second firing is started, a precharge current based on a difference between a voltage value of the AC power at the time of starting the second firing and a voltage value of capacitor 134 flows, and thereby an electric charge equivalent to the precharge current is charged to capacitor 134. Thus, the voltage value of capacitor 134 increases to a voltage value corresponding to the electric charge. Since the voltage of the AC power decreases between time TT2 and time T3 and the voltage value of capacitor 134 does not increase any further, second thyristor 112 automatically stops and the precharge current also stops.

In this way, the firing of the thyristor is repeatedly performed, and thereby the voltage value of capacitor 134 gradually increases. Then, at n-th (where n is an arbitrary natural number) firing, the firing is performed at time TTn when a predetermined time has elapsed from time Tn of the zero-cross point, and thereby the voltage value of capacitor 134 reaches a desired value.

Thereafter, the gate of first thyristor 111 and the gate of second thyristor 112 are in a state in which a voltage is always applied thereto, and operations of power factor corrector 130 and DC/DC converter 140 are started.

Further, in a case where a frequency of the AC power has fluctuated from the predetermined frequency, controller 150 controls such that the firing of the thyristor is not performed after the predetermined time from when the zero-cross point has been reached.

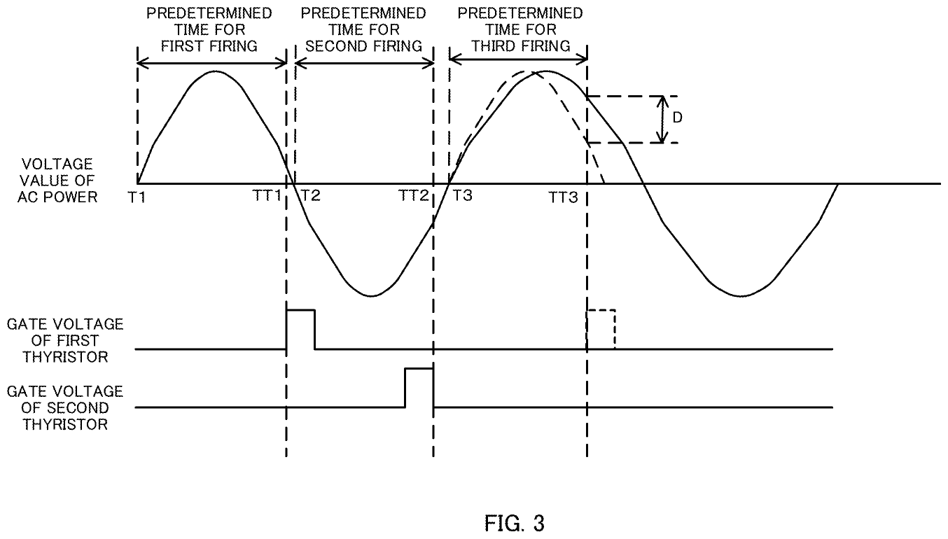

As illustrated in FIG. 3, there is a case where a frequency of AC power output from external AC power supply 10 fluctuates. The solid line in FIG. 3 indicates an example in which the frequency of the AC power in a second period (after time T3) is smaller than the frequency of the AC power in a first period (from time T1 to time T3). The broken line in FIG. 3 indicates an example in which the frequency of the AC power in the second period has not fluctuated from the frequency of the AC power in the first period.

For example, in a case where the frequency of the AC power has fluctuated such that the frequency of the AC power in the second period becomes smaller than the frequency of the AC power in the first period, third firing is performed based on a predetermined time for the third firing set in accordance with predetermined times for firing in the first period (first firing and second firing). That is, the firing of first thyristor 111 is started at time TT3 when the predetermined time for the third firing has elapsed from time T3 that is the zero-cross point of the AC power in the second period.

Accordingly, when the frequency of the AC power has fluctuated, a malfunction occurs in which difference value D between a voltage value at time TT3 at the time of starting the firing in a case where the frequency of the AC power has not fluctuated (see the broken line) and a voltage value at time TT3 in a case where the frequency of the AC power has fluctuated (see the solid line) becomes large (hereinafter, the malfunction will be referred to as “erroneous firing”). When difference value D described above becomes large due to the erroneous firing, a difference value between a voltage value of capacitor 134 and a voltage value of the AC power at the time of starting the firing may become excessive, and further an excessive inrush current may occur.

In the present embodiment, however, controller 150 controls such that the firing of the thyristor is not performed after the predetermined time in a case where the frequency of the AC power has fluctuated from the predetermined frequency so that the thyristor is not fired at time TT3. As a result, it is possible to prevent an inrush current from being generated due to a fluctuation in the frequency of the AC power. Note that, FIG. 3 illustrates an example in which the firing of first thyristor 111 is not performed at time TT3 since the voltage value of the AC power relating to the third firing is positive.

Specifically, controller 150 determines whether the frequency of the AC power has fluctuated from the predetermined frequency by detecting a voltage waveform of the AC power until a predetermined time elapses from when the zero-cross point has been reached.

In more detail, controller 150 sets respectively voltage ranges of a plurality of voltage values for each predetermined timing within one period of the AC power in accordance with the predetermined frequency. The respective voltage values are, for example, voltage values of the AC power within a period before that of a current time, and are stored in a storage (not illustrated). The predetermined timing is a timing determined in accordance with the frequency of the AC power and is 1 ms, for example.

For example, a voltage value to be compared with a voltage value of the voltage waveform after time T3 in FIG. 3 is that of the voltage waveform of one period from time T1 to time T3. A voltage value of the voltage waveform from time T1 to time T3 is detected by voltage detector 120 for each predetermined timing, and is stored in the storage or the like for each predetermined timing. Note that, the voltage waveform to be compared may be the voltage waveform of one period further before that of time T1.

Then, controller 150 reads voltage values corresponding to each timing from the storage, and sets voltage ranges of the voltage values.

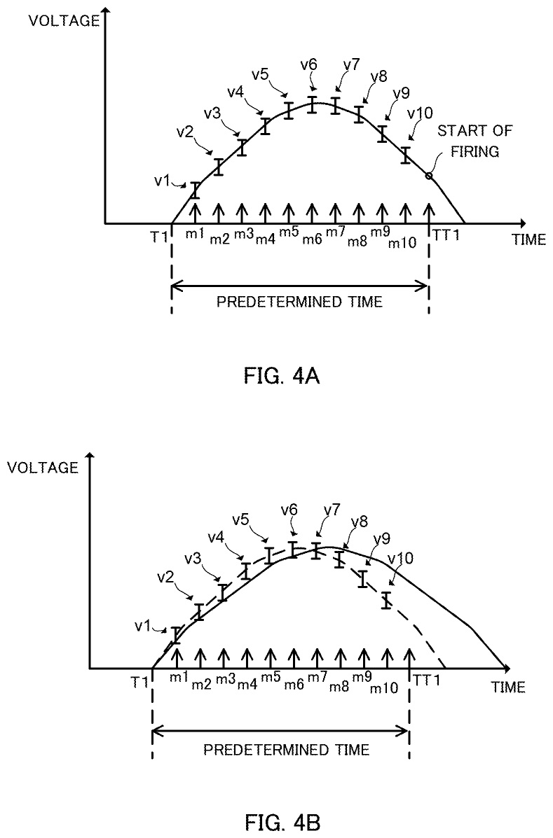

Specifically, as illustrated in FIG. 4A, controller 150 sets voltage ranges of respective voltage values of AC power for each predetermined timing during a predetermined time. FIG. 4A illustrates an example in which voltage ranges v1, v2, v3, v4, v5, v6, v7, v8, v9, and v10 are set at respective timings of times m1, m2, m3, m4, m5, m6, m7, m8, m9, and m10.

In a case where a voltage value of the AC power does not deviate from at least one of the voltage ranges set at a timing corresponding to the voltage value, controller 150 determines that the frequency of the AC power has not fluctuated from the predetermined frequency. In a case where a voltage value of the AC power deviates from at least one of the voltage range set at a timing corresponding to the voltage value, controller 150 determines that the frequency of the AC power has fluctuated from the predetermined frequency.

For example, in an example illustrated in FIG. 4B, the voltage of the AC power at time m1 (see the solid line) is within voltage range v1 set by a voltage of the AC power in a period before that of time m1 (see the broken line), controller 150 determines that the frequency of the AC power has not fluctuated from the predetermined frequency at time m1.

On the other hand, since the voltage of the AC power at time m3, for example, is outside voltage range v3 set by a voltage of the AC power in a period before that of time m3, controller 150 determines that the frequency of the AC power has fluctuated from the predetermined frequency at time m3.

In a case where the frequency of the AC power has fluctuated from the predetermined frequency, controller 150 does not control the firing of the thyristor during a predetermined period (for example, three periods). Then, controller 150 resumes the control of the firing of the thyristor after the predetermined period.

In this way, in a case where the frequency of the AC power has fluctuated, it is possible to resume the control of the firing of the thyristor after waiting for the frequency of the AC power to return to normal by the predetermined period having elapsed.

Note that, the predetermined period may be configured to fluctuate in accordance with an amount of fluctuation in the frequency of the AC power. For example, the predetermined period may be configured to be longer as an amount of fluctuation in the frequency of the AC power is larger. Thus, it is possible to ensure a lot of time for the frequency of the AC power to return to normal.

Further, when the control of the firing of the thyristor is resumed, the voltage value of capacitor 134 may fluctuate due to an electric discharge or the like. Accordingly, controller 150 may be configured to resume the control of the firing of the thyristor after setting the predetermined time described above in accordance with the voltage value of capacitor 134.

Thus, it is possible to control the firing of the thyristor in view of a fluctuation in the voltage value of capacitor 134 after resuming the firing of the thyristor. Note that, the voltage value of capacitor 134 may be detected by a voltage detector (not illustrated).

Note that, all the voltage ranges at the respective times are set as the same range in FIG. 4A or the like, but may be set as different ranges depending on the times. For example, when voltage ranges are set such that the voltage ranges become narrower as closer to a time when the firing of the thyristor is started, it is possible to prevent an excessive current from flowing at the time of erroneous firing, and to improve the accuracy of control of the firing of the thyristor.

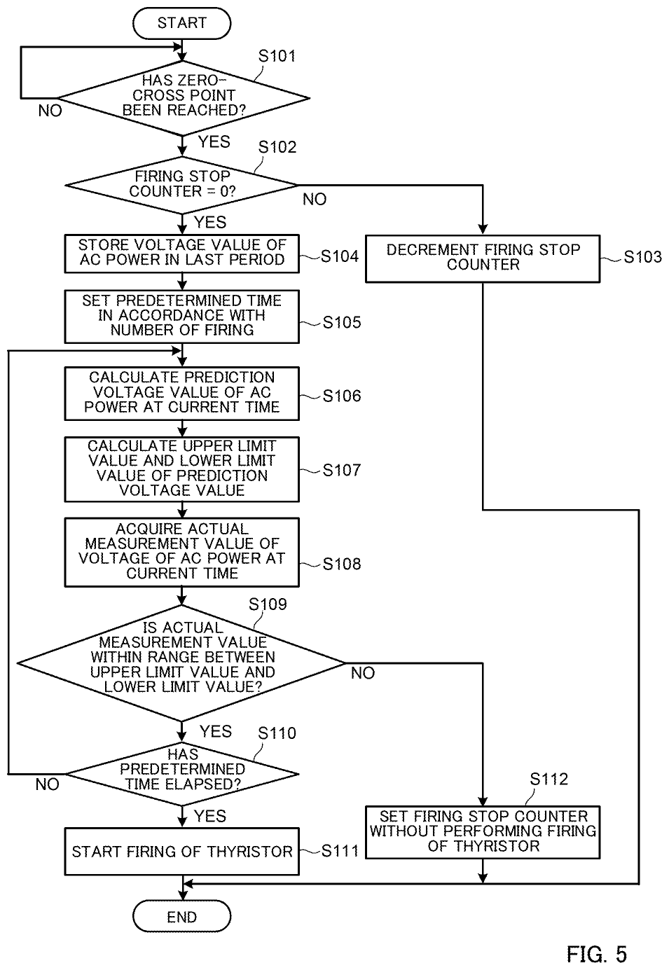

An example of operation of the thyristor firing control in power conversion apparatus 100 configured as described above will be described. FIG. 5 is a flowchart illustrating the example of operation of the thyristor firing control in power conversion apparatus 100. The processing in FIG. 5 is executed, for example, (1) after the input of AC power from external AC power supply 10 to power conversion apparatus 100 is started, (2) after the firing of the thyristor is started, and (3) after a firing stop counter to be described later is set. Further, the processing in FIG. 5 is repeatedly performed until the voltage value of capacitor 134 reaches a desired value.

As illustrated in FIG. 5, controller 150 determines whether the voltage of the AC power has reached the zero-cross point (step S101). As a result of the determination, in a case where the voltage of the AC power has not reached the zero-cross point (step S101, NO), the processing of step S101 is repeated.

In a case where the voltage of the AC power has reached the zero-cross point (step S101, YES), on the other hand, controller 150 determines whether the firing stop counter is at 0 (step S102). The firing stop counter is set in accordance with the predetermined period when the firing of the thyristor is not performed in step S112 to be described later.

As a result of the determination, in a case where the firing stop counter is not at 0 (step S102, NO), controller 150 decrements the firing stop counter (step S103). After step S103, this control ends.

In a case where the firing stop counter is at 0 (step S102, YES), on the other hand, controller 150 causes the voltage value of the AC power in the last period to be stored in the storage or the like (not illustrated) (step S104).

Next, controller 150 sets the predetermined time in accordance with the number of firing (step S105). Controller 150 calculates a prediction voltage value of the AC power at a current time (step S106). Then, controller 150 calculates an upper limit value and a lower limit value of the prediction voltage value (step S107). Further, controller 150 acquires an actual measurement value of the voltage of the AC power at the current time (step S108).

Next, controller 150 determines whether the actual measurement value is within a range between the upper limit value and the lower limit value (step S109). As a result of the determination, in a case where the actual measurement value is within the range between the upper limit value and the lower limit value (step S109, YES), controller 150 determines whether the predetermined time has elapsed from a time when the zero-cross point has been reached in step S101 (step S110).

As a result of the determination, in a case where the predetermined time has not elapsed (step S110, NO), the processing returns to step S106. In a case where the predetermined time has elapsed (step S110, YES), on the other hand, controller 150 starts the firing of the thyristor (step S111).

In a case where the actual measurement value is not within the range between the upper limit value and the lower limit value in the determination of step S109 (step S109, NO), controller 150 sets the firing stop counter to a predetermined value (for example, 3) without performing the firing of the thyristor (step S112). After step S111 or step S112, this control ends.

According to the present embodiment configured as described above, the firing of the thyristor is not performed in a case where the frequency of the AC power has fluctuated so that it is possible to prevent erroneous firing of the thyristor, and further to suppress generation of an excessive inrush current generated due to the erroneous firing.

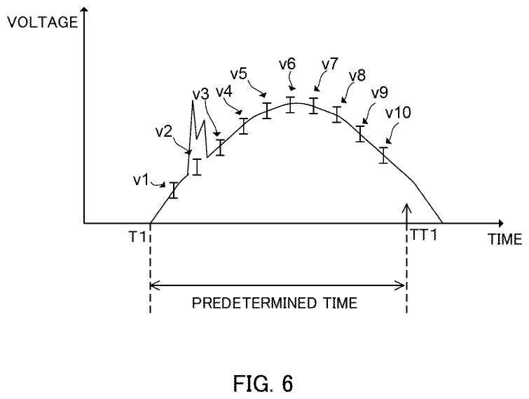

Further, even in a case where the frequency of the AC power has not fluctuated and the voltage of the AC power has suddenly fluctuated as illustrated in FIG. 6, a voltage value of the AC power at a timing at which the voltage has fluctuated deviates from a voltage range at the timing. The example illustrated in FIG. 6 is an example in which a voltage value of the AC power deviates from voltage range v2. Thus, when a voltage value of the AC power deviates from a voltage range, the voltage value may diverge from a voltage value that is assumed when performing the firing, and erroneous firing may be performed.

However, the present embodiment is capable of detecting a voltage fluctuation of AC power even in such a case, and is therefore capable of preventing erroneous firing from being performed due to a voltage fluctuation of AC power.

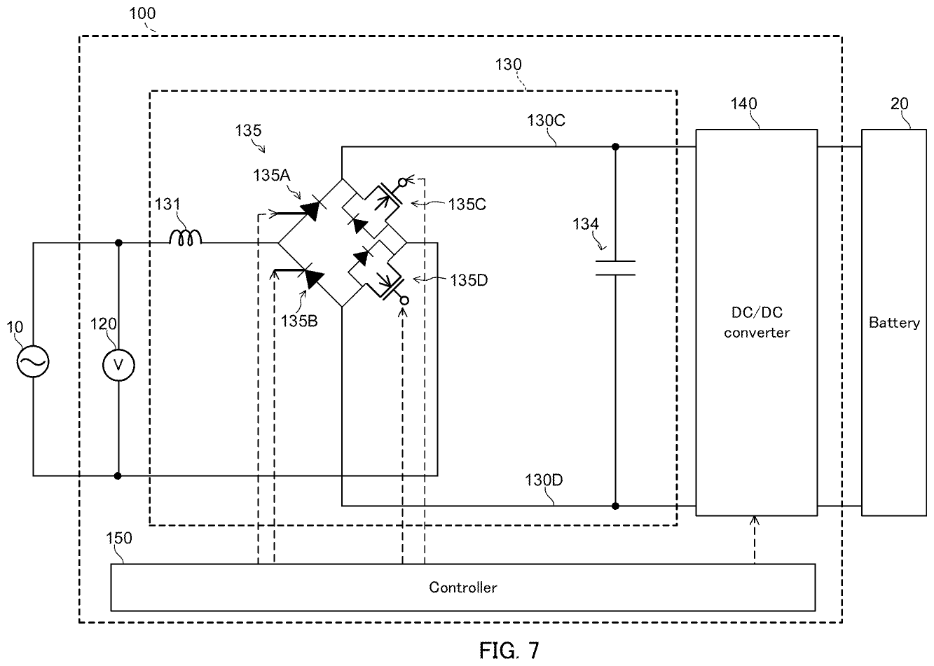

Note that, although rectifier 110 including a thyristor is provided at a stage preceding power factor corrector 130 in the embodiment described above, the present disclosure is not limited thereto. For example, as illustrated in FIG. 7, rectifier 135 including a thyristor may be provided in power factor corrector 130.

Power conversion apparatus 100 illustrated in FIG. 7 includes voltage detector 120, power factor corrector 130, DC/DC converter 140, and controller 150. Voltage detector 120 and DC/DC converter 140 are the same as in the configuration illustrated in FIG. 1.

Power factor corrector 130 includes coil 131, capacitor 134, and rectifier 135. Coil 131 includes one end connected to a positive electrode of external AC power supply 10, and the other end connected to rectifier 135. Capacitor 134 includes one end connected to output wiring 130C of power factor corrector 130, and the other end connected to ground wiring 130D of power factor corrector 130.

Rectifier 135 includes a bridge circuit formed of first thyristor 135A, second thyristor 135B, first switching device 135C, and second switching device 135D.

First thyristor 135A includes an anode connected to the other end of coil 131, and a cathode connected to output wiring 130C of power factor corrector 130. First thyristor 135A includes a gate connected to controller 150.

Second thyristor 135B includes an anode connected to ground wiring 130D of power factor corrector 130, and a cathode connected to the other end of coil 131. Second thyristor 135B includes a gate connected to controller 150.

First switching device 135C includes a source connected to a negative electrode of external AC power supply 10, and a drain connected to output wiring 130C of power factor corrector 130. First switching device 135C includes a gate connected to controller 150.

Second switching device 135D includes a source connected to ground wiring 130D of power factor corrector 130, and a drain connected to the negative electrode of external AC power supply 10. Second switching device 135D includes a gate connected to controller 150.

Controller 150 controls first thyristor 135A, second thyristor 135B, first switching device 135C, and second switching device 135D, respectively, depending on whether a voltage value of AC power is positive or negative. Thus, power factor corrector 130 corrects, while converting the AC power into DC power, the power factor of the DC power.

Further, even with such a configuration, it is possible to prevent erroneous firing of a thyristor by controlling thyristor firing when capacitor 134 is precharged as in the embodiment described above.

Further, in the embodiment described above, in a case where the AC power has fluctuated from the predetermined frequency, it is controlled such that the firing of the thyristor is not performed during the predetermined period from the zero-cross point, but the present disclosure is not limited thereto. Since a time when the voltage value becomes a voltage value at which the firing is to be started deviates when the AC power has fluctuated from the predetermined frequency, it may also be configured, for example, such that a start time of the firing in accordance with a frequency after the fluctuation is estimated and the firing of the thyristor is then performed at the estimated start time, for example. In this way, in a case where the AC power has fluctuated from the predetermined frequency, the firing of the thyristor is not performed after the predetermined time that has been set when the AC power is at the zero-cross point, but is performed at the estimated start time. Thus, it is possible to eliminate a term when operation of power conversion apparatus 100 stops, and to improve efficiency of operation.

Further, in the embodiment described above, it is controlled such that the firing of the thyristor is not performed with deviation of a voltage value of the AC power from a voltage range at a timing corresponding to the voltage value, but the present disclosure is not limited thereto. For example, it may also be controlled such that the firing of the thyristor is not performed with occurrences of a predetermined number of timings at which each voltage value of the AC power deviates from its voltage range.

Further, controller 150 may also determine whether the thyristor is fired in accordance with a particular timing within the predetermined time. For example, controller 150 may determine such that the firing of the thyristor is not performed in a case where a voltage value of the AC power deviates, at a timing relatively close to a start time of the firing such as a timing closer to a start time of the firing than a time when the AC power reaches its peak value, from a voltage range set at the timing. The reason for this is that in a case where a voltage value of the AC power deviates, at a timing close to start of the firing, from a voltage range as assumed, it is considered highly possible that a voltage value of the AC power does not return to a voltage range as assumed at the time of starting the firing.

Further, in the embodiment described above, the predetermined timing is set such that voltage values of the AC power can be compared by using a total of ten voltage ranges of v1 to v10 within the predetermined time in FIG. 4A, but the present disclosure is not limited thereto. For example, the predetermined timing may also be set such that voltage values of the AC power can be compared by using more than ten voltage ranges or less than ten voltage ranges.

Further, the predetermined timing may also be varied depending on situations. For example, since the smaller the voltage value of capacitor 134 becomes, the larger a difference between the voltage value and a voltage value of the AC power when erroneous firing occurs is likely to become, an excessive inrush current highly likely occurs and it is necessary to perform thyristor control with high accuracy.

In such a case, controller 150 sets the predetermined timing such that the number of timings for comparing voltage ranges increases. Specifically, controller 150 sets the predetermined timing such that the number of timings for comparing voltage ranges increases as the voltage value of capacitor 134 decreases.

In this way, in a case where the voltage value of capacitor 134 is small, it is possible to easily and more finely detect a frequency fluctuation (voltage fluctuation) so that accuracy for preventing erroneous firing of the thyristor can be further improved.

Further, in the embodiment described above, voltage ranges of each voltage value for each of a plurality of predetermined timings within one period of the AC power are set, respectively. However, the present disclosure is not limited thereto, and it may also be configured such that only a voltage range of a voltage value at one timing within one period is set.

Further, in the embodiment described above, the predetermined frequency of the AC power is identified based on a detection result by voltage detector 120, but the present disclosure is not limited thereto. For example, the predetermined frequency of the AC power may also be identified by communication of power conversion apparatus 100 with a power supplying side (such as external AC power supply 10) to acquire information on the predetermined frequency. Further, the predetermined frequency of the AC power may also be identified by communication of power conversion apparatus 100 with a GPS or the like to acquire information on the frequency of the AC power of external AC power supply 10 as information related to a current position.

Further, in the embodiment described above, voltage ranges are calculated and set in accordance with each timing after the AC power has reached the zero-cross point, but the present disclosure is not limited thereto. For example, voltage ranges may also be set with reference to the predetermined frequency of the AC power and/or a table associated with an amplitude (a maximum voltage value).

Further, in the embodiment described above, controller 150 including one CPU controls rectifier 110, power factor corrector 130, and DC/DC converter 140, but the present disclosure is not limited thereto. For example, a plurality of CPUs may also control rectifier 110, power factor corrector 130, and DC/DC converter 140, respectively.

In addition, any of the embodiment described above is only illustration of an exemplary embodiment for implementing the present disclosure, and the technical scope of the present disclosure shall not be construed limitedly thereby. That is, the present disclosure can be implemented in various forms without departing from the gist or the main features thereof.

The disclosure of Japanese Patent Application No. 2018-151085, filed on Aug. 10, 2018, including the specification, drawings and abstract, is incorporated herein by reference in its entirety.

### INDUSTRIAL APPLICABILITY

The power conversion apparatus of the present disclosure is useful as a power conversion apparatus capable of preventing erroneous firing of a thyristor.

### REFERENCE SIGNS LIST

10 External AC power supply
20 Battery
100 Power conversion apparatus
110 Rectifier
111 First thyristor
112 Second thyristor
113 First diode
114 Second diode
120 Voltage detector
130 Power factor corrector
131 Coil
132 Switching device
133 Diode
134 Capacitor
140 DC/DC converter
150 Controller

1. A power conversion apparatus that converts AC power into DC power,
the power conversion apparatus comprising:
a rectifier including a thyristor;
a capacitor provided at a stage subsequent to the rectifier; and
a controller that controls firing of the thyristor, wherein
the controller causes power to be supplied to the capacitor by performing the firing of the thyristor after a predetermined time from when a voltage of the AC power has reached a zero-cross point, and sets the predetermined time short every time the firing of the thyristor is performed, the predetermined time being determined in accordance with a predetermined frequency of the AC power, the zero-cross point being where the voltage of the AC power is zero, and
in a case where a frequency of the AC power has fluctuated from the predetermined frequency, the controller performs control such that the firing of the thyristor is not performed after the predetermined time determined in accordance with the predetermined frequency.

2. The power conversion apparatus according to claim 1, wherein the controller determines whether the frequency of the AC power has fluctuated from the predetermined frequency by detecting a voltage waveform of the AC power until the predetermined time elapses from when the zero-cross point has been reached.

3. The power conversion apparatus according to claim 2, wherein:
the controller sets respectively voltage ranges of a plurality of voltage values for each predetermined timing within one period of the AC power in accordance with the predetermined frequency, and
in a case where a voltage value of the AC power deviates from at least one of the voltage ranges set at a timing corresponding to the voltage value, the controller determines that the frequency of the AC power has fluctuated from the predetermined frequency.

4. The power conversion apparatus according to claim 1, wherein in a case where the frequency of the AC power has fluctuated from the predetermined frequency, the controller does not perform the firing of the thyristor during a predetermined period.

5. The power conversion apparatus according to claim 1, comprising a voltage detector that detects a voltage value of the AC power, wherein
the controller identifies the predetermined frequency based on the voltage value of the AC power.

6. The power conversion apparatus according to claim 1, which is an on-vehicle charger that charges a battery mounted on a vehicle, the power conversion apparatus comprising:
a power factor corrector including the capacitor; and
a DC/DC converter provided at a stage subsequent to the power factor corrector, wherein
in a case where a voltage of the capacitor has reached a predetermined voltage, the controller causes the power factor corrector and the DC/DC converter to operate and causes the battery to be charged.

7. The power conversion apparatus according to claim 1, wherein the rectifier is a rectifier circuit formed of the thyristor and a diode.

8. The power conversion apparatus according to claim 1, wherein the rectifier is a rectifier circuit formed of the thyristor and a switching device.
